(19) United States
(12) Patent Application Publication
(10) Pub. No.: US 2014/0241586 A1
(43) Pub. Date: Aug. 28, 2014

(54) INFORMATION RETAINING MEDIUM AND INFORMATION PROCESSING SYSTEM

(71) Applicant: NINTENDO CO., LTD., Kyoto (JP)

(72) Inventors: Shigeru MIYAMOTO, Kyoto (JP); Yoshiaki KOIZUMI, Kyoto (JP); Takeshi HAYAKAWA, Kyoto (JP)

(73) Assignee: NINTENDO CO., LTD., Kyoto (JP)

(21) Appl. No.: 14/024,083

(22) Filed: Sep. 11, 2013

(30) Foreign Application Priority Data
Feb. 27, 2013 (JP) 2013-037335

(51) Int. Cl. G06K 9/00

(52) U.S. Cl. CPC G06K 9/00442
USPC 382/106

(57) ABSTRACT

A prepaid card 2 retaining a prepaid code 31 has a marker 3a that is capable of determining a position and attitude relative to an imaging device 15 by being imaged by the imaging device. The prepaid code 31 is information that enables predetermined value or content to be acquired without handing over the prepaid card 2.

This application is based upon and claims the benefit of priority of the prior Japanese Patent Application No. JP 2013-037335, filed on Feb. 27, 2013, the entire contents of which are incorporated herein by reference.

### FIELD

The present disclosure relates to an information retaining medium for retaining information for allowing a user to acquire predetermined value or content, and an information processing system.

### BACKGROUND AND SUMMARY

There have been proposals of prepaid cards on which a passcode printed in a passcode area is concealed by a strippable coating that can be removed by scratching formed on the passcode.

However, after the strippable coating is removed and the passcode is used, the prepaid card remains in the user's possession but without specific usage.

In order to solve the problem, the present disclosure adopts the following configuration. The present disclosure provides an information retaining medium that retains information for allowing a user to acquire predetermined value or content, wherein the information retaining medium includes a feature that is capable of determining a position and an attitude relative to an imaging device by being imaged by the imaging device, and the information is information that enables the predetermined value or content to be acquired without handing over the information retaining medium.

The information retained in the information retaining medium according to the present disclosure is information for allowing the user to acquire predetermined value or content, and includes a prepaid code, a download code, or a redeem code for a product, for example.

The information retaining medium may have a card-like shape, but the shape of the information retaining medium is not limited to a card shape; media of various shapes, such as disk and block shapes, may be used for the information retaining medium. As the way of retaining information in the information retaining medium, a technique of recording information such as by printing so that the information is visually recognizable by the user or is optically recognizable may be adopted.

The codes however are not limited to ones that are visually recognizable by the user by being fixedly present on a medium such as a prepaid card. For example, the codes may be electronically recorded on and read from a medium readable by a reader capable of communicating with the information processing apparatus.

A feature that can determine the position and attitude relative to the imaging device may be a marker for Augmented Reality (AR) processing, which is a technique to superpose various kinds of information on a real space, or a code such as a two-dimensional barcode, for example. Note that such features are not limited to dedicated markers or codes. Any symbol, character, figure, picture, or a combination thereof they can acquire display references for a virtual object may be used as the feature even if they are intended for other usage.

The information may be information for which acquisition of further value or content is limited after preset value or content is acquired.

The information may be information that causes a predetermined information processing apparatus to acquire the predetermined value or content by being input to the information processing apparatus, and the feature may be a feature that is capable of determining a position and an attitude by being imaged by an imaging device connected to the predetermined information processing apparatus.

That is, the information and features according to the present disclosure may be utilized by the same one information processing apparatus. For input of information to the information processing apparatus, various techniques such as ones based on manual input by the user, imaging, or electronic communication may be adopted.

The information may be information to be executed by an information processing apparatus to allow acquisition of content that causes display of a virtual object, and the feature may be recognized by an information processing apparatus that executes the content as a reference for determining the position and attitude of the virtual object.

This allows the user to display a virtual object using a feature provided on the information retaining medium without having to separately prepare a feature (such as a marker) for displaying a virtual object when executing the content acquired using information.

The feature may be recognized as a reference for determining the position and attitude of a virtual object that appears in predetermined content executed by an information processing apparatus, and the information may be information enabling acquisition of predetermined value or additional content for use in the predetermined content.

This allows the user to acquire predetermined value or additional content for use in predetermined content by using information provided on an information retaining medium when executing the predetermined content by using a feature provided on the information retaining medium without having to separately prepare a prepaid card or the like. The additional content is content that is used being added to the original predetermined content.

The information retaining medium may have a card-like shape, and have the information on one surface and the feature on another surface. The information retaining medium may be a prepaid card and the information may be prepaid information, for example.

The information retaining medium may further include a media holding device on which the information retaining medium is mounted so as to be removable by the user, and the media holding device may have a code to be executed by an information processing apparatus to allow acquisition of content that causes display of a virtual object, and the feature may be recognized by an information processing apparatus that executes the content as a reference for determining the position and attitude of the virtual object.

The information retaining medium may further include a media holding device on which the information retaining medium is mounted so as to be removable by the user, and the media holding device may have a feature of a different type from the feature provided on the information retaining medium.

This allows the user to display a virtual object using a feature provided on the media holding device without having to separately prepare a feature (such as a marker) for displaying a virtual object when executing acquired content.

The information retaining medium may further include a coating layer that conceals the information and is removed by the user in a predetermined manner. With this configuration, information for allowing the user to acquire predetermined value or content can be concealed under the coating layer during sale or the like and the information can be utilized after sales or the like.

The present disclosure can also be construed as an information processing system. For example, the present disclosure provides an information processing system including: the information retaining medium described above; and an information processing apparatus, where the information processing apparatus includes: an information acquiring unit that acquires the information retained in the information retaining medium; a value/content acquiring unit that allows acquisition predetermined value or content corresponding to the acquired information; a feature detecting unit that detects a feature positioned in a real space; an image generating unit that generates a virtual-space image containing a virtual object that is positioned according to the feature; and a display control unit that causes a display device to display an image such that the virtual-space image appears to be superimposed on the real space.

The display device may be connected as a peripheral to the information processing apparatus according to the present disclosure or connected over a communications network or the like. Also, the information processing apparatus according to the present disclosure may be constructed in a virtual environment such as so-called cloud.

There is not limitation in the type of augmented reality technique to which the present disclosure is applied. For example, the present disclosure is applicable to augmented reality technique of a type that displays a composite image combining a captured image with a virtual space image so that the user can view the virtual space image superimposed on the real space, or a type that projects a virtual space image in the user's view so that the user can see the virtual space image superimposed on the real space (e.g., Head-Up Display or HUD).

The information processing apparatus may further include a captured image acquiring unit that acquires a captured image captured by an imaging device, and the feature detecting unit may detect from the captured image a feature present in the real space captured in the captured image.

The display control unit causes the display device to display a composite image in which the virtual-space image is superimposed on the captured image, thereby the virtual-space image appears to be superimposed on the real space.

The present disclosure can also be construed as an information processing apparatus, an information processing system having one or more information processing apparatuses, a computer-implemented method, or a program for execution by a computer. The present disclosure may also be practiced as such a program recorded in a recording medium readable by a computer, other devices or machines. A recording medium readable by a computer or the like refers to a recording medium that stores information such as data and programs by electrical, magnetic, optic, mechanical, or chemical action, and that allows the information to be read by a computer or the like.

### BRIEF DESCRIPTION OF THE DRAWINGS

FIG. 1 is a schematic diagram showing an example non-limiting system including an information processing apparatus according to the embodiment;

FIG. 2 shows an example non-limiting code side (the top side) of a prepaid card according to the embodiment;

FIG. 3 shows an example non-limiting marker side (the underside) of the prepaid card according to the embodiment;

FIG. 4 shows an example non-limiting inner surface of a mounting sheet on which the prepaid card according to the embodiment is adhered;

FIG. 5 is a schematic diagram showing an example non-limiting functional configuration of the information processing apparatus according to the embodiment;

FIG. 6 shows an example non-limiting flowchart illustrating the flow of the process of acquiring value/content according to the embodiment;

FIG. 7 shows an example non-limiting flowchart illustrating the flow of AR processing according to the embodiment; and

FIG. 8 shows an example non-limiting display screen when a marker is being detected in the embodiment.

### DETAILED DESCRIPTION OF NON-LIMITING EXAMPLE EMBODIMENTS

An embodiment of the present disclosure will be described below with reference to the drawings. Note that the embodiment described below is intended to illustrate an example of practicing the present disclosure and not limit the present disclosure to the specific configurations mentioned below. For practicing the present disclosure, a specific configuration may be selected as appropriate to each embodiment thereof. For example, the present disclosure may be applied to an information processing system having one or more information processing apparatuses and an information processing method.

An object of the present disclosure is to enable an information retaining medium that retains information for the user to acquire predetermined value or content to be utilized by the user even after the user acquired the predetermined value or content.

System Configuration

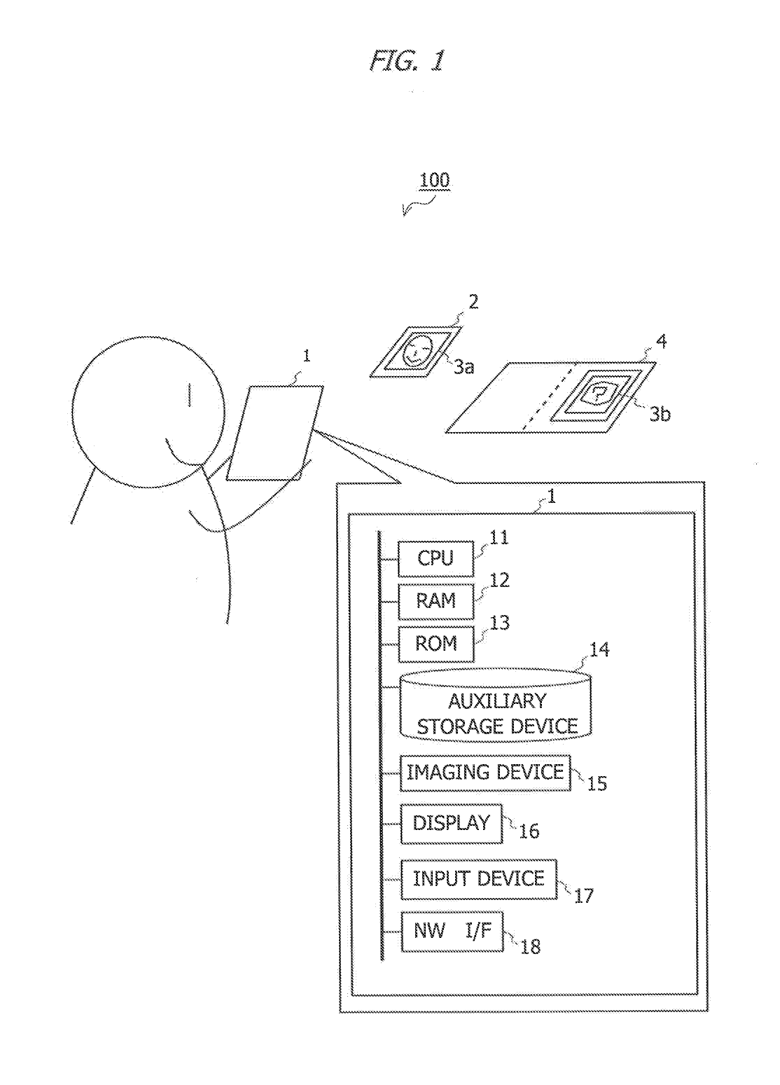

FIG. 1 illustrates a configuration of a system 100 according to an embodiment of the present disclosure. The system 100 includes an information processing apparatus 1, a prepaid card 2, and a mounting sheet 4.

The information processing apparatus 1 is an information processing apparatus in which a CPU (Central Processing Unit) 11 RAM (Random Access Memory) 12, ROM (Read Only Memory) 13, an auxiliary storage device 14, an imaging device 15, a display (display device) 16, an input device 17 such as buttons and a touch panel, and a network interface 18 are electrically connected each other. The specific hardware configuration of the information processing apparatus 1 permits omission, substitution, or addition of components as appropriate for an embodiment.

The CPU 11, or a central processing unit, controls components included in the information processing apparatus 1, such as the RAM 12 and auxiliary storage device 14, by processing instructions and data loaded into the RAM 12 and ROM 13. The RAM 12 serves as the main storage, which is controlled by the CPU 11 and to and from which instructions and data are written to and read. That is, the CPU 11, RAM 12, and ROM 13 constitute a control unit of the information processing apparatus 1.

The auxiliary storage device 14 is a non-volatile storage device, to and from which mainly information that is to be retained even after the information processing apparatus 1 is powered off, e.g., an OS (Operating System) of the information processing apparatus 1 to be loaded to the RAM 12, various programs for executing processing described below, and data for use by the information processing apparatus 1, are written and read out. The auxiliary storage device 14 may be EEPROM (Electrically Erasable Programmable ROM) or an HDD (Hard Disk Drive), for example. Alternatively, the auxiliary storage device 14 may be a portable medium that can be removably attached to the information processing apparatus 1. Examples of portable media include a memory card using EEPROM or the like, CD (Compact Disc), DVD (Digital Versatile Disc), and BD (Blu-ray Disc). An auxiliary storage device 14 in the form of a portable medium and an auxiliary storage device 14 in the form of a non-portable medium may be used in combination.

The network interface 18 sends and receives data to and from a server (not illustrated in the figures) over a network such as a LAN (Local Area Network), cellular phone network, or the Internet.

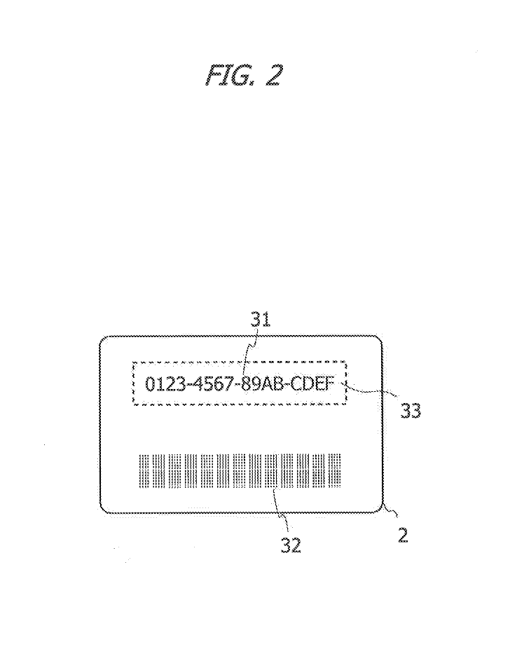

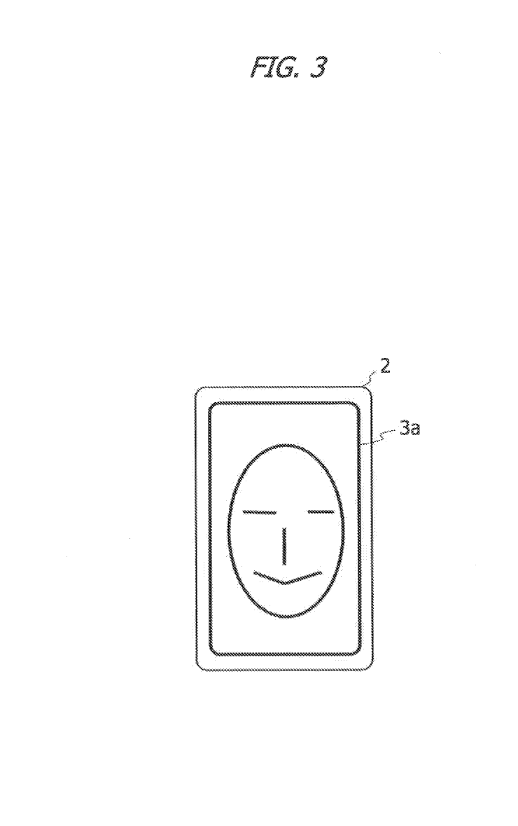

FIG. 2 illustrates a code side (the top side) of the prepaid card 2 according to the present embodiment; and FIG. 3 illustrates a marker side (the underside) of the prepaid card 2 according to the present embodiment. The prepaid card 2 is an information retaining medium that retains information for allowing a user to acquire predetermined value or content. The present embodiment uses a prepaid code 31 as the information allowing the user to acquire predetermined value or content. While the present embodiment uses a card-like medium as the information retaining medium, the shape of the information retaining medium is not limited to a card shape; media of various shapes such as disk and block shapes may be used for the information retaining medium.

The prepaid card 2 carries a prepaid code 31 thereon, which is printed on the code side and input by the user when acquiring predetermined value or content using the information processing apparatus 1, and a barcode 32 to be read by a barcode reader or the like of a POS terminal at the time of sale at a store. The prepaid card 2 further has an AR marker 3a printed on the marker side. The prepaid code 31, barcode 32, and marker 3a may also be provided on the prepaid card 2 by techniques other than printing. Also, while according to the present embodiment the prepaid code 31 is recorded as alphanumeric characters that can be visually recognized by the user and input to the information processing apparatus 1 and the barcode 32 is recorded as a pattern visible to the user and also optically recognizable, these codes are not limited to ones that are visually recognizable by the user by being fixedly present on a medium such as a prepaid card. For example, the codes may be electronically recorded on and read from a medium (e.g., EEPROM) that is readable by a reader capable of communicating with the information processing apparatus 1. For reading the codes by a reader, either a wired or wireless (e.g., RFID) scheme may be adopted.

The prepaid code 31 used in the present embodiment is information that allows the user to acquire predetermined value or content by entering the code into the information processing apparatus 1, without handing over the prepaid card 2. The prepaid code 31 is also information for which acquisition of further value or content is limited after preset value or content has been acquired. Specifically, the prepaid code 31 according to the present embodiment is invalidated in the system and its reuse is limited once addition of a system-specific currency equivalent to a predetermined amount (e.g., 2,000 yen) or downloading of predetermined content (e.g., a predetermined game program) is completed.

According to the present embodiment, the prepaid code 31 is hidden by a coating layer so that it is not visible to the user while the card is sold at a store. The coating layer is omitted in the figures. Broken-line frame 33 indicated in FIG. 2 represents an area 33 covered by the coating layer. The coating layer can be removed by the user by stripping after purchasing the prepaid card 2. The coating layer may be made of material that can be removed by scratching with a coin or a nail, that can be removed using adhesive tape, or that can be peeled off like a seal, for example.

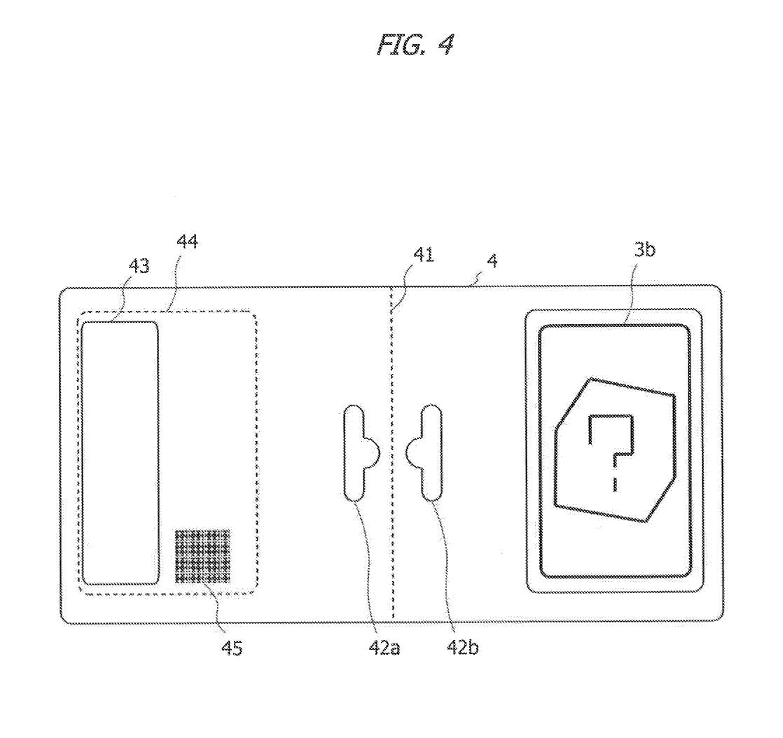

FIG. 4 illustrates the inner surface of the mounting sheet 4, on which the prepaid card 2 according to the present embodiment is adhered. The mounting sheet 4 according to the present embodiment is a media holding device for holding the prepaid card 2 such that the prepaid card 2 can be removed by the user, and is used for displaying the prepaid card 2 at a store. The outer surface of the mounting sheet 4 is omitted in the figure. The mounting sheet 4 has a folding line 41, holes 42a and 42b, an opening 43, a holding portion 44, a download code 45, and a marker 3b. When sold at a store, the prepaid card 2 is displayed being adhered to or mounted on the holding portion 44 of the mounting sheet 4 and folded along the folding line 41 so that the inner surface faces inward. The holes 42a and 42b are formed at positions that coincide with each other when the mounting sheet 4 is folded along the folding line 41, so that they align with each other to form a single insertion hole when the mounting sheet 4 is folded. At the time of display at a store, a display rail of a store fixture can be inserted to the insertion hole. The code side of the prepaid card 2 is fixed to the prepaid card holding portion 44 of the mounting sheet 4 such as by press fitting so that the prepaid card 2 can be easily removed by the user.

The opening 43 is formed at such a position that allows the barcode 32 on the prepaid card 2 to be seen from outside of the mounting sheet 4 through the opening 43 when the prepaid card 2 is fixed to the holding portion 44 of the mounting sheet 4. Thus, the barcode 32 can be scanned by a POS terminal and the prepaid card 2 can be sold at a store to the user without removing the prepaid card 2 from the mounting sheet 4. That is, the user can purchase the prepaid card 2 with the prepaid card 2 remaining adhered to the mounting sheet 4 and take the prepaid card 2 with the mounting sheet 4 with him/her. Also, the prepaid code 31 on the prepaid card 2 according to the present embodiment is activated to become available for use in acquisition of the predetermined value or content in response to the corresponding barcode 32 being scanned by a POS terminal and processed in a POS system. For the prepaid card to have such a feature, a POSA (Point of Sales Activation) card may be adopted as the prepaid card, for example.

In the present embodiment, a download code 45 for downloading predetermined content (e.g., a game program) is printed on the mounting sheet 4. This content is different from the predetermined content that can be acquired through the prepaid code 31. The content to be downloaded using the download code 45 may also be content that is executed by the information processing apparatus 1 to perform AR processing described below and generate display of a virtual object based on the marker 3a indicated on the prepaid card 2 fixed to the mounting sheet 4 and the marker 3b indicated on the mounting sheet 4.

On the prepaid card 2 and the mounting sheet 4, markers 3a and 3b (referred to as just “marker 3” when marker types are not differentiated) of different types are marked by printing or the like. The marker 3 is associated with a virtual object to be displayed on the information processing apparatus 1 and serves as an indicator of reference position and attitude in which the virtual object associated with the marker 3 is to be displayed. While FIG. 1 illustrates one prepaid card 2 and one mounting sheet 4, one, or two or more prepaid card(s) 2 and mounting sheet(s) 4 may be used. Also, although different markers 3 are indicated on the prepaid card 2 and the mounting sheet 4 in order to display different virtual objects, a prepaid card 2 and a mounting sheet 4 having the same marker indicated thereon may be used. In the present embodiment, the types of marker 3 are differentiated by representation of different graphics such as cartoon characters, and the information processing apparatus 1 displays a virtual object corresponding to the cartoon character or the like represented on the marker 3.

According to the present embodiment, a virtual object is superposed at a predetermined position relative to the associated marker 3 on the display 16 of the information processing apparatus 1. The virtual object also has top and bottom, front and rear, and left and right directions. Accordingly, the marker 3 is preferably capable of determining the display attitude of the virtual object. More specifically, the marker 3 is preferably a symbol, character, figure, picture, or a combination thereof that can determine the position and attitude relative to the imaging device 15 by being imaged by the imaging device 15.

Next, functions of the information processing apparatus 1 according to the present embodiment will be described. The information processing apparatus 1 according to the present embodiment is an information processing apparatus having a so-called AR function. The information processing apparatus 1 has the ability to superpose a virtual object in a virtual space drawn (rendered) using a virtual camera on a captured image of a real space taken by the imaging device 15 and display the resulting image on the display 16. In the present embodiment, a virtual object is three-dimensional image data. The virtual object may be two-dimensional image data, however.

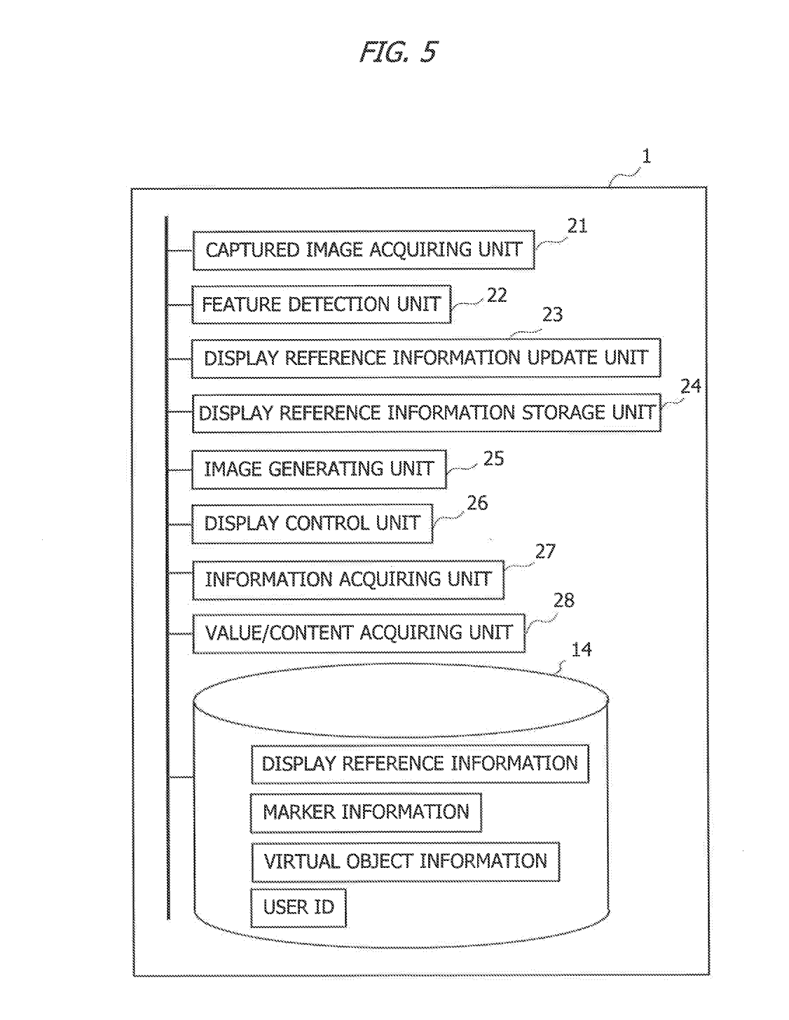

FIG. 5 schematically illustrates the functional configuration of the information processing apparatus 1 according to the present embodiment. The information processing apparatus 1 according to the present embodiment functions as an information processing apparatus that includes a captured image acquiring unit 21, a feature detection unit 22, a display reference information update unit 23, a display reference information storage unit 24, an image generating unit 25, a display control unit 26, an information acquiring unit 27, and a value/content acquiring unit 28, by the CPU 11 interpreting and executing various programs loaded in the RAM 12. While the present embodiment describes a case where these functions are all carried out by a general-purpose CPU 11, some or all of the functions may be achieved by one or more special-purpose processors.

The captured image acquiring unit 21 acquires a captured image captured by the imaging device 15. The feature detection unit 22 performs image processing, e.g., pattern matching, on the image captured by the imaging device 15 to detect markers 3 contained in the image. Detection of markers 3 may use an image recognition engine, for example.

The display reference information update unit 23 acquires information that serves as the reference indicating a position and an attitude in the space captured in the captured image on the basis of the detected marker 3, and updates display reference information. According to the present embodiment, even when the camera moves or the marker 3 is moved, display reference information stored in the display reference information storage unit 24 is updated in accordance with the latest marker position and attitude relative to the camera.

The display reference information storage unit 24 stores display reference information used for determining the position and attitude of a virtual object to be positioned in a virtual space. Display reference information according to the present embodiment refers to a reference used for indicating the position and attitude of a virtual object in a virtual space. Display reference information, however, may also be a reference used for indicating one of the position and attitude of a virtual object in a virtual space. A reference acquiring process in the present embodiment acquires a marker coordinate system whose origin point is the center point of a marker 3 and which uses three axes orthogonal to one another as display reference information for each marker 3. The display reference information however may use something other than marker coordinate system, such as a captured image itself. It is also possible to use a single marker coordinate system in common for multiple markers 3. By defining a virtual space coordinate system with reference to a marker 3 positioned in a real space, the real space can be mapped to a virtual space. Mapping between a real space and a virtual space may use a scheme other than use of marker coordinate system.

A virtual object to be positioned in a virtual space in the present embodiment is positioned in the marker coordinate system of the marker 3 with which the virtual object is associated. The marker coordinate system can be determined by calculating the position and attitude of the marker 3 relative to the imaging device 15 based on how the marker 3 contained in a captured image appears. The position and attitude of a virtual camera in the marker coordinate system are made to correspond with the position and attitude of the imaging device 15 present in the real space. Therefore, when a virtual space is defined based on the marker 3 and the position or imaging direction of the imaging device 15 is changed in the virtual space, the image of the virtual space displayed on the display 16 also changes.

The image generating unit 25 draws or renders a virtual space image by placing in a virtual space a virtual object whose position and attitude are determined according to display reference information stored in the display reference information storage unit 24 and generating a virtual space image as seen from the virtual camera. Then, for executing the AR function mentioned above, the information processing apparatus 1 according to the present embodiment then generates a composite image by superimposing the virtual space image containing the virtual object generated by the image generating unit 25 on the captured image acquired by the captured image acquiring unit 21.

The display control unit 26 has the display 16, which is a display device, display the generated composite image. This gives the user a sense that the virtual object is really present in the real space.

The information acquiring unit 27 acquires the prepaid code 31 carried on the prepaid card 2 as an information retaining medium. In the present embodiment, the information acquiring unit 27 acquires the prepaid code 31 by having the user enter the prepaid code 31 he/she has read through the input device 17. The prepaid code 31 may be acquired in a different manner, however. For example, the prepaid code 31 may be optically acquired by imaging the printed prepaid code 31 with the imaging device 15 and performing character recognition or the like on the image, or when the prepaid code 31 is electronically maintained, it may be input via other kind of receiver (such as a USB terminal or RFID receiver not illustrated).

The value/content acquiring unit 28 sends the prepaid code 31 acquired by the information acquiring unit 27 to a server so as to allow the user to obtain predetermined value or content corresponding to the prepaid code 31. According to the present embodiment, a predetermined amount of system-specific currency is acquired as the predetermined value corresponding to the prepaid code 31, and predetermined content is acquired as the predetermined content corresponding to the prepaid code 31.

Next, information retained by the information processing apparatus 1 according to the present embodiment will be described. In addition to the display reference information stored by the display reference information storage unit 24 described above, the information processing apparatus 1 retains marker information, virtual object information, and a user ID.

The marker information is information regarding marker 3. The marker information includes a marker ID for identifying the marker 3, marker image, marker size, corresponding virtual object ID, position/attitude of the virtual object, and display size for the virtual object, for example. The marker image is an image representing the outer appearance of the marker 3. The marker size is information indicating the dimension of the marker 3, such as vertical and horizontal lengths of the marker 3. The display reference information update unit 23 of the information processing apparatus 1 can determine the distance between the imaging device 15 and the marker 3, the attitude of the marker 3 and the like, namely the position/attitude information and marker coordinate system for the marker 3, from how the marker 3 contained in a captured image appears and based on the marker image and marker size. The corresponding virtual object ID is an identification number of a virtual object to be displayed at a position corresponding to the marker 3. Note that two or more virtual objects may be associated with one marker 3. In the present embodiment, marker information includes the virtual object IDs of virtual objects that are managed according to the corresponding marker coordinate system. The position and attitude of a virtual object is represented by a position (coordinate values) and an attitude (vectors) in a marker coordinate system. The display size of a virtual object is information indicating the size of the virtual object to be positioned in a marker coordinate system. Marker information is present for each of markers 3 that are used in the system 100.

Virtual object information is information regarding a virtual object to be displayed at a position corresponding to the marker 3. Virtual object information includes a virtual object ID for identifying the virtual object and data on the virtual object, for example. The virtual object information is present for each of virtual objects that are used in the system 100.

A user ID is identification information used by the server for identifying the user of the information processing apparatus 1. The information processing apparatus 1 reads the user ID from the auxiliary storage device 14 and sends it to the server when necessary. Alternatively, the user ID may be entered by the user when necessary.

Processing Flow

Next, the flow of processing executed in the present embodiment is described. Note that the specific actions and their order in the processing illustrated in the flowchart according to the present embodiment are an example of practicing the present disclosure; specific processing actions and their order may be selected as appropriate for an embodiment of the present disclosure.

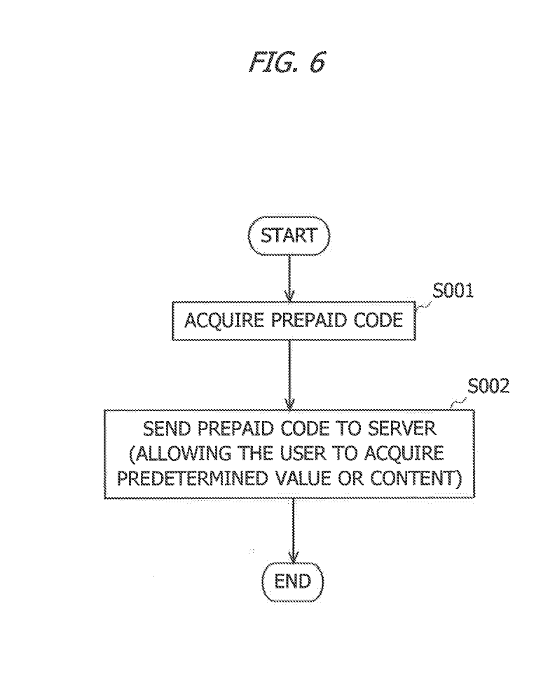

FIG. 6 is a flowchart illustrating the flow of the process of acquiring value/content according to the present embodiment. The value/content acquisition process illustrated in the flowchart starts in response to a user operation requesting input of prepaid code 31 being accepted by the information processing apparatus 1.

The information acquiring unit 27 acquires the prepaid code 31 entered to the information processing apparatus 1 by the user using the input device 17 (step S001). The value/content acquiring unit 28 sends the prepaid code 31 acquired at step S001 to the server with the user ID of the information processing apparatus 1. The user ID is information used at the server for identifying the user of the information processing apparatus 1, and it may be acquired through the user's input when entering the prepaid code 31 or by reading a prepaid code prestored in, for example, the auxiliary storage device 14.

When the prepaid code 31 is a prepaid code 31 for allowing the user to acquire a predetermined system-specific currency that can be used for purchasing content or the like, transmission of the prepaid code 31 by the value/content acquiring unit 28 is a request to the server for addition of the system-specific currency. Upon receiving the request for adding the system-specific currency, the server adds the system-specific currency in an amount determined by the prepaid code 31 to a user account on the server associated with the received user ID. The system-specific currency can be used by the user of the account (which can be identified by the user ID) to purchase online content or the like equivalent to amount of the currency.

When the prepaid code 31 is a prepaid code 31 allowing the user to acquire predetermined content, transmission of the prepaid code 31 by the value/content acquiring unit 28 is a request to the server for downloading the predetermined content. Upon receiving the content downloading request, the server sends content such as a game program corresponding to the prepaid code 31 to the information processing apparatus 1 and has the information processing apparatus 1 download the content.

By sending such requests to the server, the value/content acquiring unit 28 allows the user to acquire predetermined value or content (step S002). The process illustrated in the flowchart then ends.

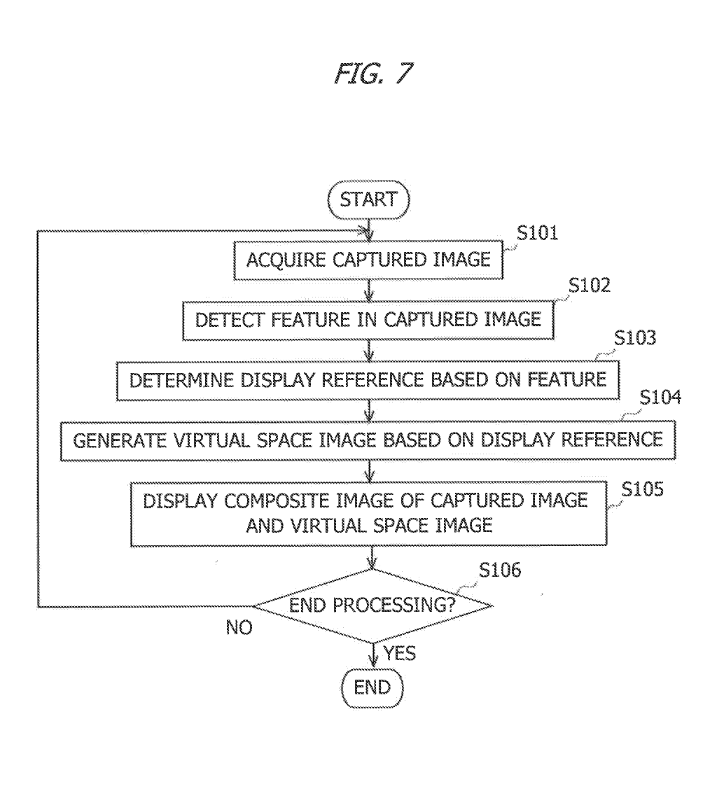

FIG. 7 is a flowchart illustrating the flow of AR processing according to the present embodiment. The AR processing illustrated in the flowchart starts in response to a user operation for activating the AR function being received on the information processing apparatus 1. Information stored by the display reference information storage unit 24 is initialized when the AR function is activated and the display reference information storage unit 24 does not store display reference information during activation of the AR function. The process according to the present embodiment is repetitively executed per frame at the rate of 60 frames/second.

At steps S101 and S102, a captured image is acquired and markers 3 are detected in the captured image. The captured image acquiring unit 21 acquires a captured image captured by the imaging device 15 (step S101). After the captured image is acquired, the feature detection unit 22 detects any marker 3 that corresponds to the marker image included in marker information from the captured image as features in the space of the captured image. Detection of markers 3 may use a generic image recognition engine. The flow then proceeds to step S103.

At step S103, processing for reference acquisition is performed for each marker 3. For each one of the detected markers 3, the display reference information update unit 23 acquires real-space position/attitude information for that marker 3 and updates the display reference information of that marker 3. More specifically, the display reference information update unit 23 determines the position and attitude of a marker 3 in the real space based on its position in the captured image, the result of comparison between the marker size included in the marker information and the size of the marker 3 contained in the captured image, and distortion of the marker 3 in the captured image relative to the marker image included in the marker information. The display reference information update unit 23 updates the display reference information stored in the display reference information storage unit 24 with the real-space position/attitude information for the marker 3 thus acquired. The flow then proceeds to step S104.

At step S104, a virtual space image is generated. The image generating unit 25 creates an image of a virtual space containing one or more virtual objects of which at least one of position and attitude has been determined according to display reference information and which are positioned in a marker coordinate system, from the viewpoint of a virtual camera positioned at the same position as the imaging device 15 in the marker coordinate system. Data on the virtual object for use in drawing of the object is taken from virtual object information. A virtual object may be animated by causing it to change every one or several frames. The animation may be change of the facial expression or motion of a cartoon character as a virtual object, for example. The flow then proceeds to step S105.

At step S105, processing for display is performed. The display control unit 26 generates a composite image by superimposing the virtual space image on the captured image and outputs the composite image to the display 16 for display thereon.

As mentioned above, processing described in step S101 to S105 of the flowchart is executed per frame. Thus, the processing described in the flowchart is repetitively and periodically executed from step S101 until the AR function is deactivated responsive to a user operation or the like (step S106).

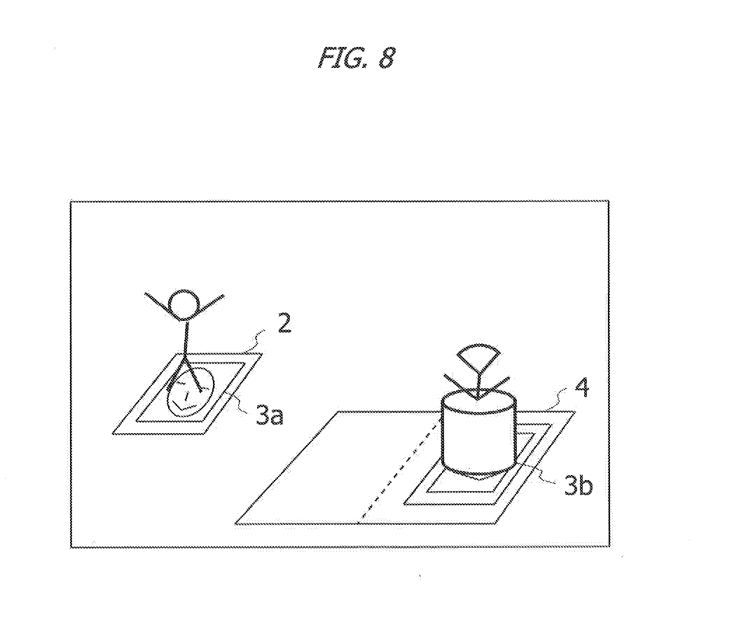

FIG. 8 illustrates an example display screen on the display 16 for a case when an AR function is implemented by the AR processing according to the present embodiment. In a display area, a composite image generated by superimposing a virtual space image on a captured image is displayed.

As mentioned above, information stored by the display reference information storage unit 24 is initialized when the AR function is activated and the display reference information storage unit 24 does not store display reference information during activation of the AR function. Thus, if no marker 3 is contained in a captured image immediately after the AR function of the information processing apparatus 1 is activated in response to a user operation, no virtual object is positioned in virtual space and the captured image being taken by the imaging device 15 is displayed on the display 16.

When a marker 3 comes into the imaging range of the imaging device 15 and the marker 3 is contained in the captured image, the display reference information update unit 23 updates display reference information based on the marker 3 detected by the feature detection unit 22 and a virtual object is drawn by the image generating unit 25 in the position and attitude corresponding to the marker 3. As a result, a composite image in which the virtual object is superimposed on the marker 3 is displayed on the display 16.

The information processing apparatus 1 may vary the contents of display including the virtual object or vary other processing based on the number of markers 3, their types, combinations, or conditions such as position/attitude. For example, the information processing apparatus 1 is able to identify the types and/or combination of markers 3 based on the marker IDs of detected markers 3. The information processing apparatus 1 can also determine the positional relationship between markers 3 from the relationship of position/attitude information of multiple markers 3 acquired, for example. The positional relationship that can be determined may include the order of markers 3 and relationship of orientation (such as angle) among markers 3.

In the present embodiment, the prepaid code 31 may be a prepaid code 31 for acquiring content that includes AR processing using marker 3. That is, the prepaid code 31 may also be a prepaid code 31 to be executed by the information processing apparatus 1 for acquiring content in which a virtual object is to be displayed, and the marker 3 may be a marker 3 to be recognized as the reference for determining the position and attitude of the virtual object by the information processing apparatus 1, which executes the content thus acquired.

In the present embodiment, the prepaid code 31 may also be a prepaid code 31 for content-specific currency (in-game currency) that can be used for charging and payment in content (e.g., a game) that includes AR processing using markers 3. Specifically, the marker 3 may be recognized as the reference for determining the position and attitude of a virtual object that appears in content executed by the information processing apparatus 1, and the prepaid code 31 may be a prepaid code 31 with which predetermined value for use in the content or additional content can be acquired. The additional content may be content that is executed in the original content, for example.

According to the present disclosure, an information retaining medium that retains information for allowing the user to acquire predetermined value or content can be utilized by the user even after acquiring the predetermined value or content.

Variations of the Embodiment

In the above-described embodiment, the display control unit 26 displays a composite image in which a virtual space image is superimposed on a captured image on a display device so that the user can see the virtual space image overlapping the real space. However, the display control unit 26 may display an image on a display device so that the user can see a virtual space image as if it overlaps the real space; the present disclosure is not limited to the scheme of displaying a composite image. For example, the present disclosure may also be applied to an augmented reality technique of a type that projects a virtual space image in the user's view so that the user can see a virtual space image being superimposed on the real space, such as a HUD (Head-Up Display) or the technique of projecting a virtual space image on glasses worn by the user.

While marker coordinate system is used as display reference information in the example discussed in the above-described embodiment, the display reference information may be any information that is obtained from the real space and that can be used as the reference for at least one of the position and attitude of a virtual object in a virtual space. For example, the display reference information may be a captured image itself. When a captured image is used as display reference information, the image generating unit 25 extracts the display reference for a virtual object from a captured image stored as display reference information for each frame.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. An information retaining medium that retains information for allowing a user to acquire predetermined value or content, comprising:
a feature capable of determining a position and an attitude relative to an imaging device by being imaged by the imaging device,
wherein the information includes information that enables the predetermined value or content to be acquired without handing over the information retaining medium.

2. The information retaining medium according to claim 1, wherein the information includes information for which acquisition of further value or content is limited after preset value or content is acquired.

3. The information retaining medium according to claim 1, wherein the information includes information that causes a predetermined information processing apparatus to acquire the predetermined value or content by being input to the information processing apparatus, and
wherein the feature is a feature that is capable of determining a position and an attitude by being imaged by an imaging device connected to the predetermined information processing apparatus.

4. The information retaining medium according to claim 1, wherein the information includes information for allowing acquisition of content that is executed by an information processing apparatus and cause the information processing apparatus to display a virtual object, and
wherein the feature is recognized by an information processing apparatus that executes the content as a reference for determining the position and attitude of the virtual object.

5. The information retaining medium according to claim 1, wherein the feature is recognized as a reference for determining the position and attitude of a virtual object that appears in predetermined content executed by an information processing apparatus, and
wherein the information includes information enabling acquisition of predetermined value or additional content for use in the predetermined content.

6. The information retaining medium according to claim 1, wherein the information retaining medium has a card-like shape and holds the information on one surface and the feature on another surface.

7. The information retaining medium according to claim 1, wherein the information retaining medium is mounted on a media holding device so as to be removable by the user,
the media holding device has a code to be executed by an information processing apparatus to allow acquisition of content that causes display of a virtual object, and
the feature is recognized by an information processing apparatus that executes the content as a reference for determining the position and attitude of the virtual object.

8. The information retaining medium according to claim 1, wherein the information retaining medium is mounted on a media holding device so as to be removable by the user,
wherein the media holding device has a feature of a different type from the feature provided on the information retaining medium.

9. The information retaining medium according to claim 1, further comprising a coating layer that conceals the information and is removed by the user in a predetermined manner.

10. The information retaining medium according to claim 1, wherein the information includes prepaid information and the information retaining medium is a prepaid card.

11. An information processing system comprising:
the information retaining medium according to claim 1; and
an information processing apparatus,
wherein the information processing apparatus includes:
an information acquiring unit that acquires the information retained by the information retaining medium;
a value/content acquiring unit that allows acquisition of predetermined value or content corresponding to the acquired information;
a feature detecting unit that detects a feature positioned in a real space;
an image generating unit that generates a virtual-space image containing a virtual object that is positioned according to the feature; and
an display control unit that causes a display device to display an image such that the virtual-space image appears to be superimposed on the real space.

12. The information processing system according to claim 11, wherein the information processing apparatus further includes a captured image acquiring unit that acquires a captured image captured by an imaging device, and
wherein the feature detecting unit detects from the captured image a feature present in the real space captured in the captured image.

13. The information processing system according to claim 11, wherein the display control unit causes the display device to display a composite image in which the virtual-space image is superimposed on the captured image, thereby the virtual-space image appears to be superimposed on the real space.
